(19) United States
(12) Patent Application Publication
(10) Pub. No.: US 2026/0145492 A1
(43) Pub. Date: May 28, 2026

(54) RETRACTABLE SUN VISOR

(71) Applicant: Ford Global Technologies, LLC, Dearborn, MI (US)

(72) Inventors: Thomas J. Susko, Saint Clair Shores, MI (US); Macit Aktas, Windsor (CA); Jung Jeon, Northville, MI (US)

(73) Assignee: Ford Global Technologies, LLC, Dearborn, MI (US)

(21) Appl. No.: 18/961,598

(22) Filed: Nov. 27, 2024

(51) Int. Cl. B60J 3/02

(52) U.S. Cl. CPC B60J 3/0265

(57) ABSTRACT

A retractable sun visor for a vehicle has a visor body and a visor support arm coupled to the visor body. A visor mount assembly is configured to be mounted proximate to a headliner on the vehicle. The visor mount assembly is operatively coupled to the visor arm. The visor mount assembly has a bias spring operatively coupled to a locking feature that prevents rotation of the visor arm in a first upper position and that is moveable downward against the bias spring to a second lower position to allow the visor arm and user body to rotate to multiple use positions.

### FIELD OF THE DISCLOSURE

The present disclosure generally relates to vehicle sun visors for use on vehicles, and more particularly relates to a vehicle sun visor that is retractable between front and side positions.

### BACKGROUND OF THE DISCLOSURE

Motor vehicles are commonly equipped with sun visors that are typically connected to the headliner under the roof generally forward of the driver and front passenger seats. The sun visors typically connect to the headliner via a support arm and a pivot mechanism that may be rotated between stowed and deployed positions to provide shade from sunlight. It may be desirable to provide for a sun visor that may be efficiently moved between multiple use positions.

### SUMMARY OF THE DISCLOSURE

According to a first aspect of the present disclosure, a retractable sun visor for a vehicle has a visor body and a visor support arm coupled to the visor body. A visor mount assembly is configured to be mounted proximate to a headliner on a vehicle. The visor mount assembly is operatively connected to the visor arm. The visor mount assembly has a bias spring operatively coupled to a locking feature that prevents rotation of the visor arm in a first upper position and that is moveable downward against the bias spring to a second downward position to allow the visor arm and user body to rotate to multiple use positions.

Embodiments of the first aspect of the present disclosure can include any one or a combination of the following features:
a plunger mechanism coupled to the visor mount assembly;
the locking feature comprises a pin operatively coupled to the support arm, and wherein the pin is blocked from rotating in the first upper position and is free to rotate in the second lower position;
the visor mount assembly has a housing with a slot configured to allow the pin to
move within the slot and block rotation of the visor support arm;
the pin is free to rotate in the second lower position to allow rotation of the visor support arm;
the bias spring biases the plunger to the first upper position;
the locking feature comprises a cam surface and a cam follower coupled to the support arm to slide on the cam surface;
the bias spring biases the cam follower to the first upper position;
the visor support arm has a first portion configured to allow the visor body to rotate about a horizontal axis on the first portion; and
the visor support arm has a second portion configured to rotate about a vertical axis.

According to a second aspect of the present disclosure, a vehicle has a roof mounted headliner and a retractable sun visor. The retractable sun visor has a visor body and a visor support arm coupled to the visor body. A visor mount assembly is configured to be mounted proximate to a headliner on a vehicle. The visor mount assembly is operatively connected to the visor arm. The visor mount assembly has a bias spring operatively coupled to a locking feature that prevents rotation of the visor arm in a first upper position and that is moveable downward against the bias spring to a second downward position to allow the visor arm and user body to rotate to multiple use positions.

Embodiments of the second aspect of the present disclosure can include any one or a combination of the following features:
the retractable sun visor further comprises a plunger mechanism coupled to the visor mount assembly;
the locking feature comprises a pin operatively coupled to the support arm, and wherein the pin is blocked from rotating in the first upper position and is free to rotate in the second lower position;
the visor mount assembly has a housing with a slot configured to allow the pin to move within the slot and block rotation of the visor support arm;
the pin is free to rotate in the second lower position to allow rotation of the visor support arm;
the bias spring biases the plunger to the first upper position;
the locking feature comprises a cam surface and a cam follower coupled to the support arm to slide on the cam surface;
the bias spring biases the cam follower to the first upper position;
the visor support arm has a first portion configured to allow the visor body to rotate about a horizontal axis on the first portion; and
the visor support arm has a second portion configured to rotate about a vertical axis.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a perspective view of a forward portion of a passenger compartment of a motor vehicle equipped with a pair of sun visor assemblies, according to one example;

FIG. 2 is an enlarged perspective view of a sun visor configured in a forward stowed position, according to a first embodiment;

FIG. 2A is a schematic view of a visor mount assembly for mounting the sun visor to a roof mounted headliner on the vehicle according to the first embodiment of FIG. 2;

FIG. 3 is a perspective view of the sun visor assembly shown in FIG. 2 with the sun visor rotated about a horizontal axis to a first forward deployed position generally forward of a seat and rearward of the windshield;

FIG. 3A is a cross-sectional view of the visor mount assembly taken through line IIIA-IIIA of FIG. 3 with the sun visor configured in the first forward deployed position;

FIG. 4 is a perspective view of the sun visor assembly in the first forward deployed position with the pivot arm extended downward;

FIG. 4A is a cross-sectional view through the visor mount assembly further illustrating the pivot arm in the downward extended position shown in FIG. 4;

FIG. 5 is a perspective view of the sun visor assembly rotated about a vertical axis to a second deployed side position in front of a side window;

FIG. 5A is a cross-sectional view taken through line VA-VA of FIG. 5 with the visor in the second deployed side position;

FIG. 5B is a cross-sectional view taken through line VB-VB of FIG. 5 with the visor in the second deployed side position;

FIG. 6 is an exploded view of the visor mount assembly according to the first embodiment shown in FIG. 2;

FIG. 6A is a cross-sectional exploded view of the visor mount assembly taken through line VI-VI of FIG. 6;

FIG. 7 is a schematic view of a visor mount assembly according to a second embodiment with the visor in the forward position;

FIG. 8 is a cross-sectional view of the visor mount assembly taken through line VIII-VIII of FIG. 8 with the visor arm in the upward position;

FIG. 9 is a cross-sectional view of the visor mount assembly as shown in FIG. 8 with the visor arm partially extended downward;

FIG. 10 is a cross-sectional view of the visor mount assembly as shown in FIG. 9 with the visor arm fully extended downward;

FIG. 11 is an exploded view of the visor mount assembly shown in FIG. 7; and

FIG. 11A is a cross-sectional view taken centrally through the visor mount assembly shown in FIG. 11.

### DETAILED DESCRIPTION OF PREFERRED EMBODIMENTS

Reference will now be made in detail to the present preferred embodiments of the disclosure, examples of which are illustrated in the accompanying drawings. Wherever possible, the same reference numerals will be used throughout the drawings to refer to the same or like parts. In the drawings, the depicted structural elements are not to scale and certain components are enlarged relative to the other components for purposes of emphasis and understanding.

As required, detailed embodiments of the present disclosure are disclosed herein; however, it is to be understood that the disclosed embodiments are merely exemplary of the disclosure that may be embodied in various and alternative forms. The figures are not necessarily to a detailed design; some schematics may be exaggerated or minimized to show function overview. Therefore, specific structural and functional details disclosed herein are not to be interpreted as limiting, but merely as a representative basis for teaching one skilled in the art to variously employ the present disclosure.

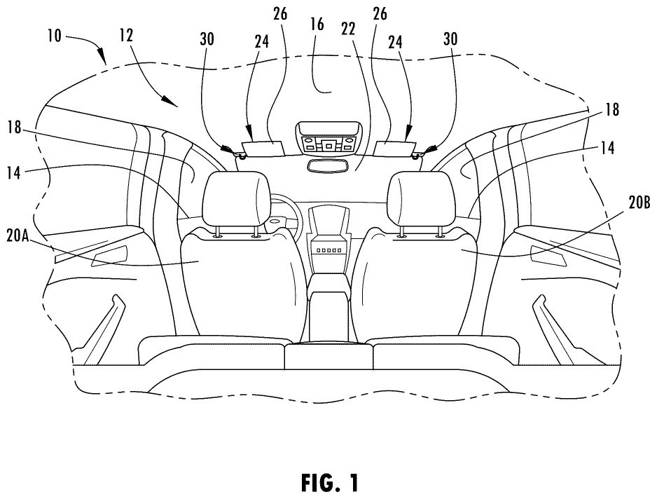

For purposes of description herein, the terms “upper,” “lower,” “right,” “left,” “rear,” “front,” “vertical,” “horizontal,” and derivatives thereof shall relate to the concepts as oriented in FIG. 1. However, it is to be understood that the concepts may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The present illustrated embodiments reside primarily in combinations of method steps and apparatus components related to a retractable sun visor for a vehicle. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

As used herein, the term “and/or,” when used in a list of two or more items, means that any one of the listed items can be employed by itself, or any combination of two or more of the listed items, can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises. a” does not, without more constraints, preclude the existence of additional identical elements in the process, method, article, or apparatus that comprises the element.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

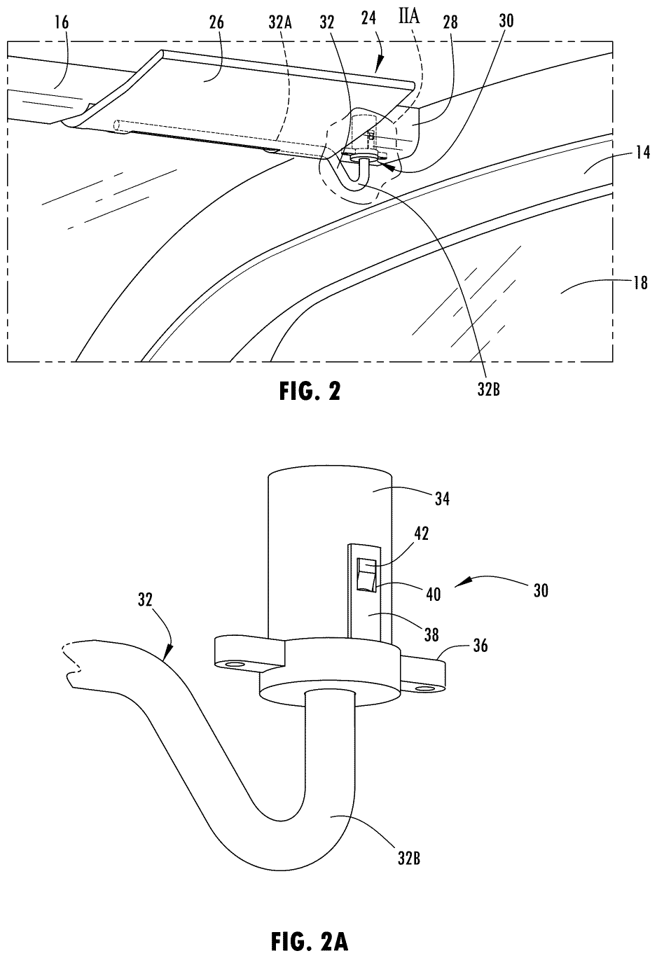

Referring to FIGS. 1-2, a motor vehicle 10 is generally illustrated having a pair of visor assemblies 24 connected to a roof mounted headliner 16 in the cabin interior 12 which is typically forward of passenger seating in the motor vehicle 10. The motor vehicle 10 may include a motor vehicle for transporting passengers as is commonly known in the art. Each visor assembly 24 is generally positioned rearward of a front windshield 22 and is shown mounted to the roof mounted headliner 16 via a visor mount assembly 30 having an extendable plunger mechanism as shown and described herein. A user, such as a seated driver sitting in a front driver's seat 20A or a passenger seated in front passenger seat 20B, may apply downward force to extend a pivot arm downward and pivot the pivot arm corresponding visor body of the visor assembly 24 between a forward deployed use position generally extending downward and rearward of the windshield 22 to shade sunlight that enters the vehicle 10 through the windshield 22 in the first deployed position and to rotate the sun visor pivot arm and visor body about a vertical axis to a deployed side position to shade sunlight entering from a side window 18 shown located in a side door 14.

The visor assembly 24 has a visor body 26 that may be pivoted about the visor support arm 32 in the horizontal axis to a generally horizontal upward stowed position toward the roof mounted headliner 16 which is referred to as a non-use stowed position. The visor body 26 and visor support arm 32 of the visor assembly 24 may be rotated downward about the horizontal axis to the first deployed forward position and further pivoted about the vertical axis rearward and towards a side window by approximately 90-120 degrees adjacent to the side window 18 to a second deployed position or any position in between. It should be appreciated that the motor vehicle 10 may include one or more sun visor assemblies 24 located forward of the driver's seat 20A, forward of the passenger seat 20B in the motor vehicle 10 or elsewhere in the vehicle to shade sunlight and to provide one or more visor assembled or mounted accessories, such as a vanity mirror.

The sun visor assembly 24 illustrated in the first embodiment has an extendable spring-biased plunger mechanism in the visor mount assembly 30 shown in FIGS. 2-6A. The visor body 26 defines a main body portion of the visor assembly which may be positioned to block direct sunlight and may contain accessories such as one or more mirrors and lighting devices that may be utilized by a passenger. In the example shown, the visor body 26 has a generally rectangular shaped planar body. The visor body 26 is supported by the visor support arm 32 having a first portion 32A extending on a horizontal axis which connects to the visor body 26 and a second portion 32B extending on a vertical axis which is supported by a visor mount assembly 30 which is shown in FIG. 2, according to the first embodiment.

The visor assembly 24 is actuable using force by a user to a plurality of deployed use positions and a stowed position. The visor body 26 may be rotated about the first portion 32A aligned on the horizontal axis of the visor support arm 32 between the stowed upward forward position and any downward rotated deployed position. The visor body 26 may also be rotated about the second portion 32B aligned on the vertical axis of the visor support arm 32 by a user pulling with force downward to extend the visor support arm 32 downward from the visor mount assembly 30 along with the visor body 26 from an upper locked position that prevents rotation about the vertical axis to a lower unlocked position to enable the visor body 26 and visor support arm 32 to be rotated about the vertical axis to a deployed side position or any position between the forward and side deployed positions.

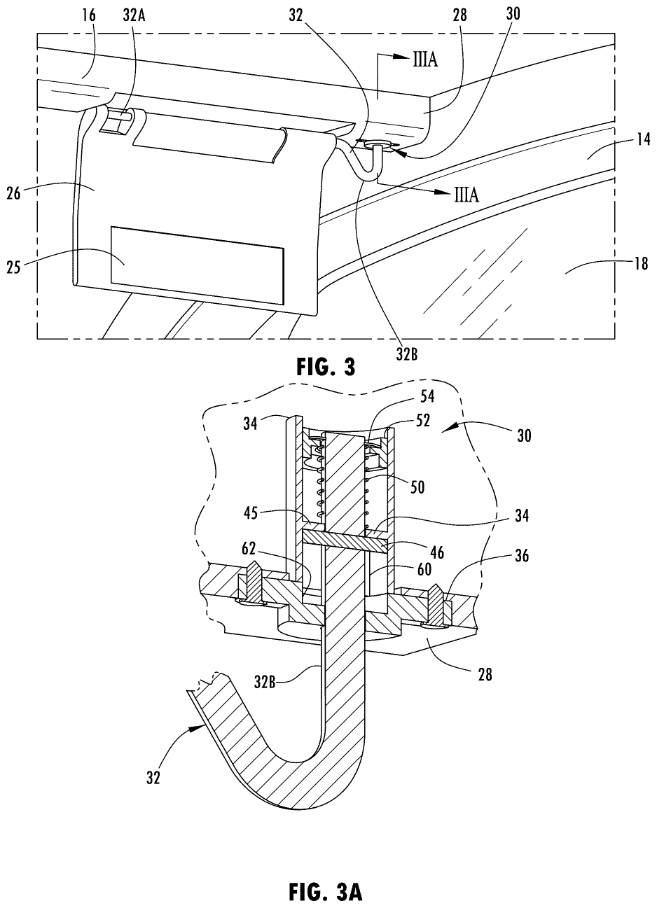

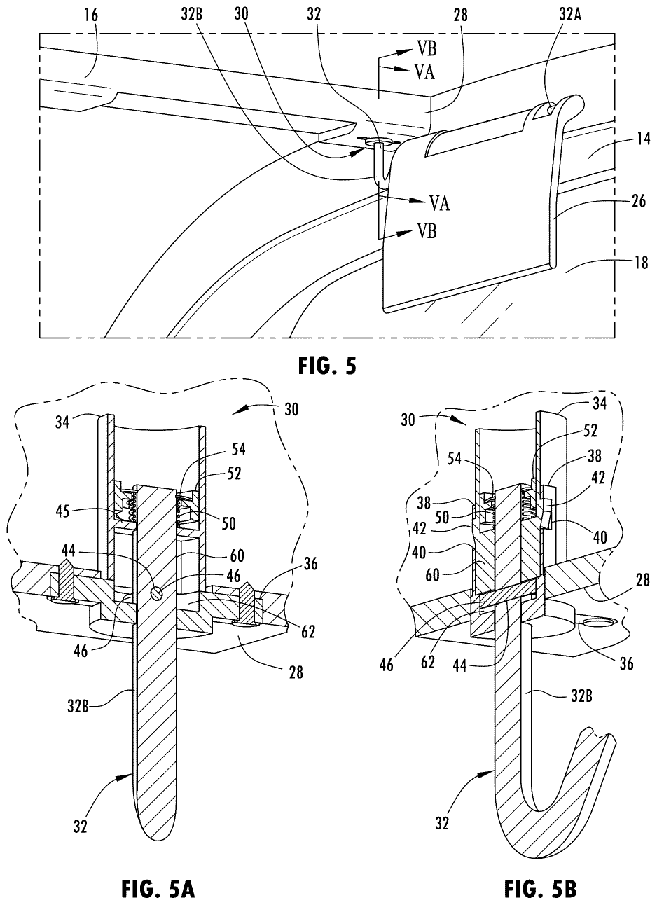

The visor assembly 24 is shown in FIG. 2 in the forward stowed position with the main visor body 26 rotated upward substantially against the headliner 16. The visor assembly 24 may be rotated about the first portion 32A of the support arm 32 to the downward deployed position as shown in FIG. 3 which enables the blocking of sunlight entering through the windshield 22 and presents a mirror 25, such as a vanity mirror on one side, for use by a person seated in front of the visor assembly 24. The visor assembly 24 includes a visor mount assembly 30 having a spring-biased plunger mechanism, according to a first embodiment shown in FIGS. 2A-6A, which controls the pivoting movement of the visor body 26 between a forward visor position and a rotated side visor position such as is shown in FIG. 5 in which the visor body 26 rotates in the range of at least 0 to 90 degrees, and more particularly about 0 to 120 degrees to a position proximate to the side window 18 to enable the blocking of sunlight through the side window 18.

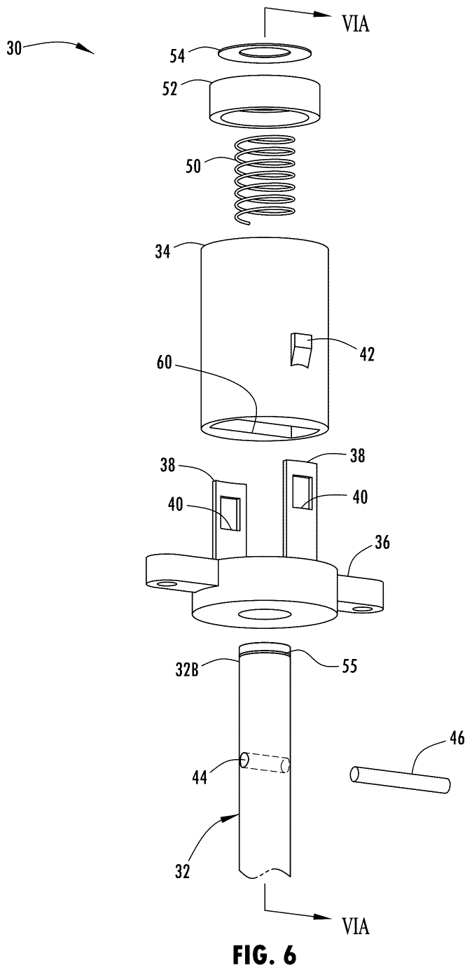

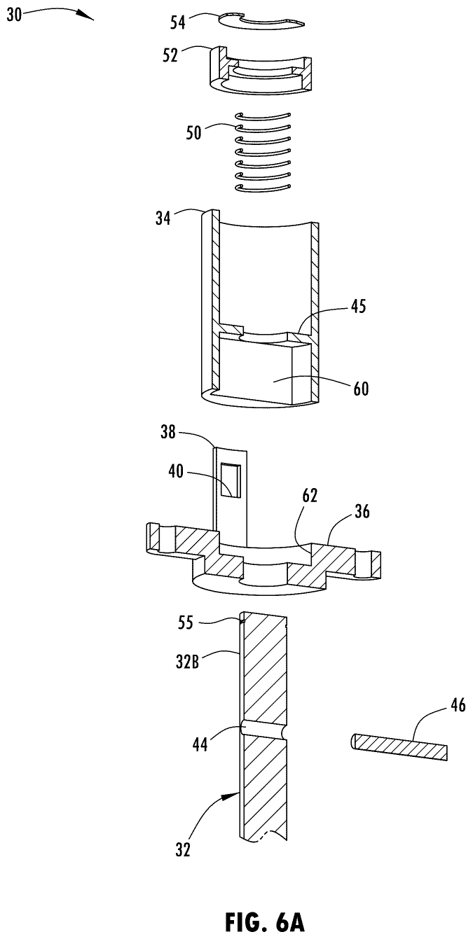

The visor mount assembly 30 is shown in FIGS. 2-6A having a housing 34 generally mounted within the headliner 16 and attached onto a cap 36 which serves as a mounting plate that may be attached to the headliner 16 via fasteners, for example. The cap 36 has opposing arms 38 with connector holes 40 which engage and lock onto tabs 42 on the exterior of the housing 34 that slide into connection on an angled surface and lock into the holes 40 in arms 38. The second portion 32B of the visor support arm 32 extends vertically into the housing 34 and engages a sleeve like plunger cap 52 which serves as a spring-loaded plunger mechanism that may move vertically between an elevated position as seen in FIG. 3A and an extended downward position as seen in FIGS. 5A and 5B. The plunger cap 52 may be cylindrical and is operatively coupled to a bias spring 50 within the housing 34 which biases the bias support arm 32 to the upward elevated position. The upper end of the second portion 32B has a ring-shaped slot 55 that receives a push nut 54 as seen in FIGS. 6 and 6A. As such, the push nut 54 is fixed onto the second portion 32B.

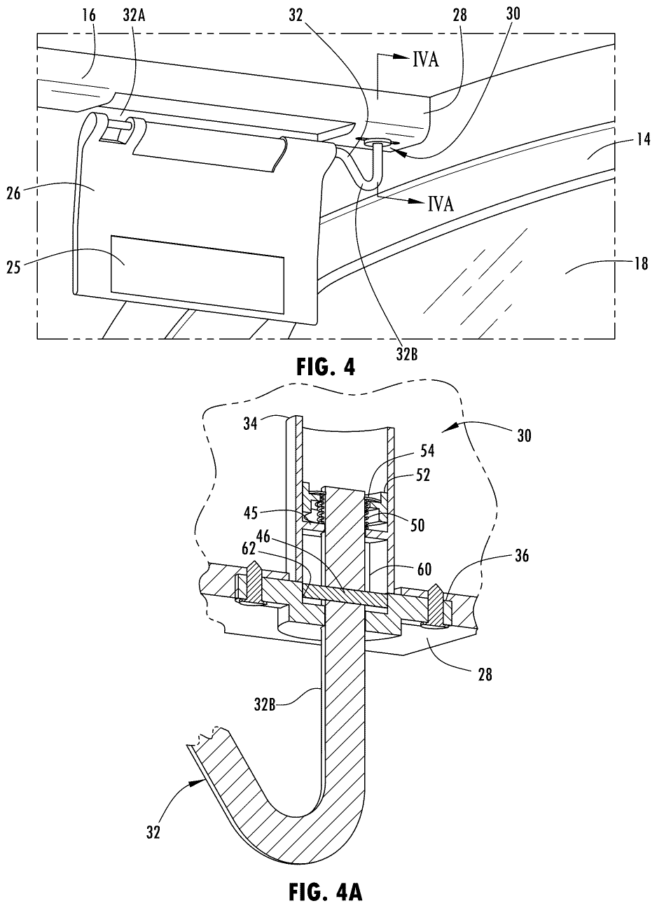

The second portion 32B of the visor support arm 32 has a cylindrical opening 44 extending axially therethrough for receiving a pin 46 which extends beyond the width of the second portion 32B on both sides. Pin 46 is shown in FIG. 3A extending within a slot 60 in housing 34 and engaging an upper limit 45 in the biased upward position. When a user forcibly pulls the visor support arm 32 downward toward the extended position, pin 46 moves downward within the slot 60 in the lower portion of the housing 34 downward into enlarged size region 62 in the upper surface of the cap 36 which enables the second portion 32B of the visor support arm 32 to rotate from the position seen in FIG. 4A to the position seen in FIGS. 5A and 5B with the visor body 26 and visor support arm 32 rotated proximate to the side window 18. In this position, the visor support arm 32 remains in the downward extended position.

It should be appreciated that the visor support arm 32 remains in the downward extended position and may be rotated back to the forward position. In doing so, the pin 46 is rotated with rotation of the visor support arm 32 to the forward position to align with the pin 46 with slot 60 and is forced back into slot 60 and upwards and upwards towards the end of upper limit 45 due to the bias spring 50 to thereby lock the visor body 26 and visor support arm 32 in the upper position and prevents rotation about the vertical axis in that upper position.

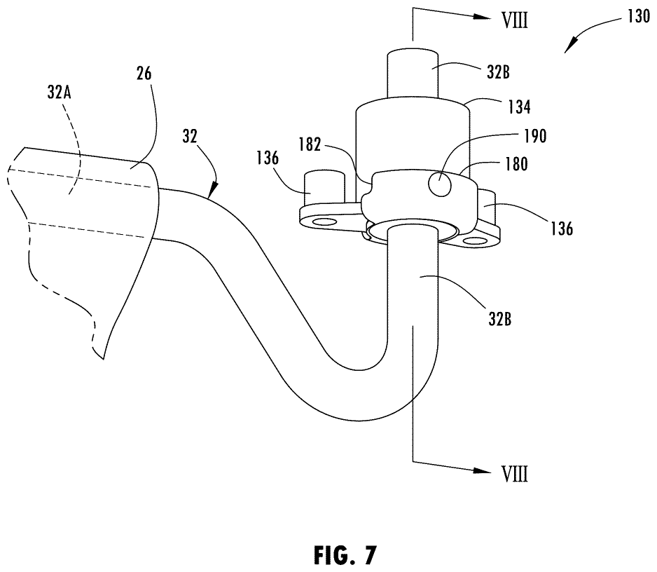

Referring to FIGS. 7-11A, the visor assembly 24 is shown having a visor mount assembly 30 with an extendable cam actuated plunger mechanism, according to a second embodiment. In this embodiment, the visor support arm 32 likewise includes a first portion 32A extending through the visor body 26 along a horizontal axis and the second portion 32B extending along the vertical axis and supported within a housing 134. The housing 134 is connected to the vehicle roof mounted headliner 16 via a mounting structure 136 which may be fastened or otherwise connected to the headliner 16.

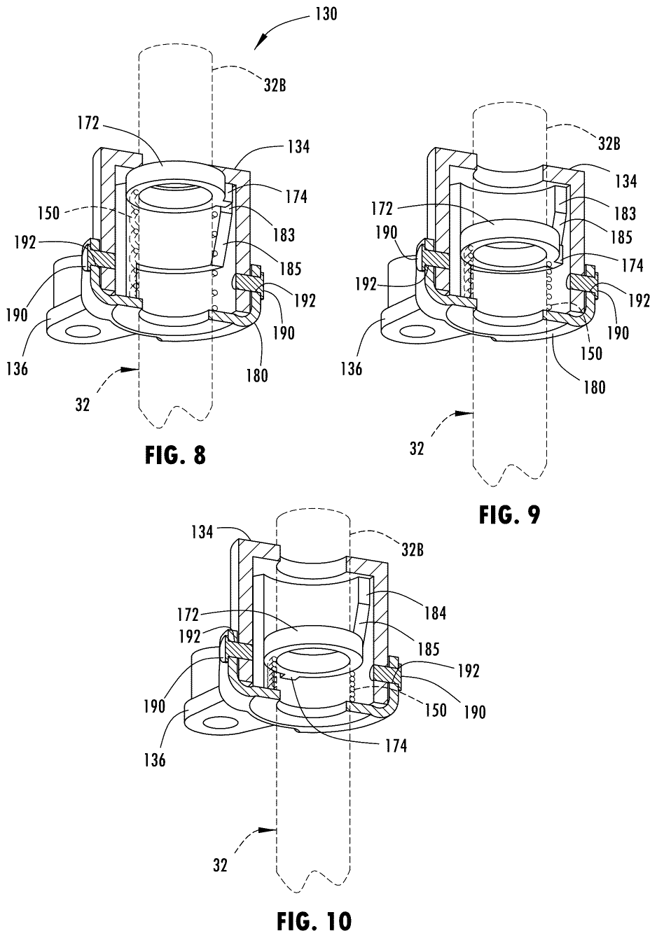

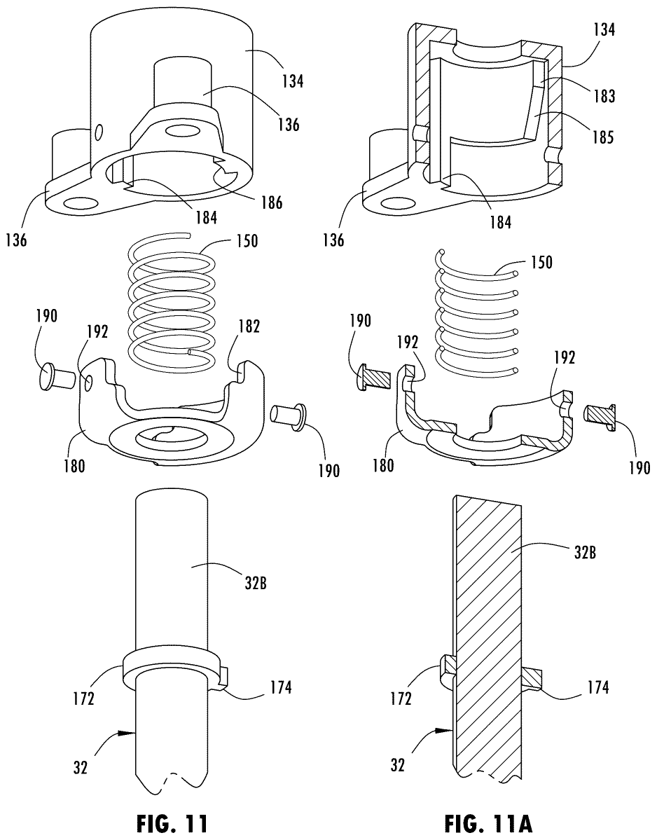

As seen in FIGS. 8-11A, a housing 134 that extends into the headliner and supported by a cap 136 defines a cylindrical chamber receiving a cylindrical plunger or ring-shaped sleeve 172 that is engaged to the second portion 32B of the visor support arm 32. The ring-shaped sleeve 172 may be connected to the second portion 32B and includes an outward protruding arm 174 that serves as a cam follower. The housing 134 as seen in FIGS. 11 and 11A has a cam cylinder 184 with a cam surface 185. The cam follower 174 is configured to follow the cam surface 185 when the second portion 32B of the visor support arm 32 is pulled downward against the bias force of bias spring 150 to extend downward and rotate from the position starting at FIG. 8 and proceeding to the position shown in FIG. 10. When the cam follower 174 reaches the bottom position against bias spring 150 as seen in FIG. 10, the second portion 32B of the visor support arm 32 has rotated to the side position proximate to the side window of the motor vehicle.

It should be appreciated that the sun visor body 26 and visor support arm 32 may be rotated back to the forward position by rotating the main body manually by hand thereby enabling the cam follower 174 to move upward with force applied by the spring bias 150 to the upward position shown in FIG. 8.

Accordingly, a retractable sun visor assembly 24 for a vehicle 10 is provided that requires a downward force applied to the visor body to move the visor body between the forward and side positions that enable the visor body to pass under any roof features such as a roof bow, thereby advantageously resulting in an efficiently controlled deployment of the visor assembly.

It is to be understood that variations and modifications can be made on the aforementioned structure without departing from the concepts of the present disclosure, and further it is to be understood that such concepts are intended to be covered by the following claims unless these claims by their language expressly state otherwise.

What is claimed is:

1. A retractable sun visor for a vehicle, the sun visor comprising:
a visor body;
a visor support arm coupled to the visor body; and
a visor mount assembly configured to be mounted proximate to a headliner on the vehicle, the visor mount assembly operatively coupled to the visor arm, wherein the visor mount assembly has a bias spring operatively coupled to a locking feature that prevents rotation of the visor arm in a first upper position and that is moveable downward against the bias spring to a second lower position to allow the visor arm and user body to rotate to multiple use positions.

2. The sun visor of claim 1, further comprising a plunger mechanism coupled to the visor mount assembly.

3. The sun visor of claim 2, wherein the locking feature comprises a pin operatively coupled to the support arm, and wherein the pin is blocked from rotating in the first upper position and is free to rotate in the second lower position.

4. The sun visor of claim 3, wherein the visor mount assembly has a housing with a slot configured to allow the pin to move within the slot and block rotation of the visor support arm.

5. The sun visor of claim 4, wherein the pin is free to rotate in the second lower position to allow rotation of the visor support arm.

6. The sun visor of claim 1, wherein the bias spring biases the plunger to the first upper position.

7. The sun visor of claim 1, wherein the locking feature comprises a cam surface and a cam follower coupled to the support arm to slide on the cam surface.

8. The sun visor of claim 7, wherein the bias spring biases the cam follower to the first upper position.

9. The sun visor of claim 1, wherein the visor support arm has a first portion configured to allow the visor body to rotate about a horizontal axis on the first portion.

10. The sun visor of claim 9, wherein the visor support arm has a second portion configured to rotate about a vertical axis.

11. A vehicle comprising:
a roof mounted headliner; and
a retractable sun visor, the sun visor comprising:
a visor body;
a visor support arm coupled to the visor body; and
a visor mount assembly configured to be mounted proximate to a headliner on the vehicle, the visor mount assembly operatively coupled to the visor arm, wherein the visor mount assembly has a bias spring operatively coupled to a locking feature that prevents rotation of the visor arm in a first upper position and that is moveable downward against the bias spring to a second lower position to allow the visor arm and user body to rotate to multiple use positions.

12. The vehicle of claim 11, wherein the retractable sun visor further comprises a plunger mechanism coupled to the visor mount assembly.

13. The vehicle of claim 12, wherein the locking feature comprises a pin operatively coupled to the support arm, and wherein the pin is blocked from rotating in the first upper position and is free to rotate in the second lower position.

14. The vehicle of claim 13, wherein the visor mount assembly has a housing with a slot configured to allow the pin to move within the slot and block rotation of the visor support arm.

15. The vehicle of claim 14, wherein the pin is free to rotate in the second lower position to allow rotation of the visor support arm.

16. The vehicle of claim 11, wherein the bias spring biases the plunger to the first upper position.

17. The vehicle of claim 16, wherein the locking feature comprises a cam surface and a cam follower coupled to the support arm to slide on the cam surface.

18. The vehicle of claim 17, wherein the bias spring biases the cam follower to the first upper position.

19. The vehicle of claim 11, wherein the visor support arm has a first portion configured to allow the visor body to rotate about a horizontal axis on the first portion.

20. The vehicle of claim 19, wherein the visor support arm has a second portion configured to rotate about a vertical axis.
